(19) United States
(12) Patent Application Publication
(10) Pub. No.: US 2016/0005342 A1
(43) Pub. Date: Jan. 7, 2016

(54) METHOD OF DETECTING DEGRADATION OF DISPLAY PANEL AND DEGRADATION DETECTING DEVICE FOR DISPLAY PANEL

(71) Applicant: Samsung Display Co., Ltd., Yongin-City (KR)

(72) Inventor: Soo-Ran Park, Suwon-si (KR)

(21) Appl. No.: 14/541,598

(22) Filed: Nov. 14, 2014

(30) Foreign Application Priority Data
Jul. 2, 2014 (KR) 10-2014-0082541

(51) Int. Cl. G09G 3/00; G09G 5/10; G09G 3/32

(52) U.S. Cl. CPC G09G 3/006; G09G 3/3283; G09G 5/10; G09G 2320/041; G09G 2360/145

(57) ABSTRACT

A method of detecting degradation of a display panel and a degradation detecting device for a display panel are disclosed. The device includes a light measuring unit configured to measure the brightnesses of light emitted at first and second areas of the display panel at a plurality of measurement temperatures and generate a plurality of first and second measured amounts of the light respectively emitted at the first and second areas. The device also includes a current amount calculator configured to calculate first and second current amounts of the light emitted at the first and second areas at a predetermined target temperature respectively based at least in part on the first and second measured amounts, and a determining unit configured to compare a first ratio of the first current amount to a first initial amount and a second ratio of the second current amount to a second initial amount.

### CROSS-REFERENCE TO RELATED APPLICATION(S)

This application claims priority under 35 USC §119 to Korean Patent Applications No. 10-2014-0082541, filed on Jul. 2, 2014 in the Korean Intellectual Property Office (KIPO), the contents of which are incorporated herein in its entirety by reference.

### BACKGROUND

1. Field

The described technology relates generally to a degradation detecting method and degradation detecting device of a display panel.

2. Description of the Related Technology

Organic light-emitting diode (OLED) displays visually transmit information including images and characters by using light generated when holes and electrodes are combined with each other at an organic light emitting layer interposed between an anode and a cathode. OLED displays have been highlighted as a next-generation display because they have favorable characteristics such as a wide viewing angle, a rapid response speed, a thin profile, low power consumption, etc.

### SUMMARY OF CERTAIN INVENTIVE ASPECTS

One inventive aspect is a degradation detecting method that can accurately detect a degree of degradation of a display panel regardless of the temperature of the panel.

Another aspect is a degradation detecting device of a display panel that can accurately detect a degree of degradation of the display panel regardless of the temperature of the panel.

Another aspect is a method of detecting degradation of a display panel including storing a first initial amount of light emitted at a first area of the display panel and a second initial amount of light emitted at a second area of the display panel at a predetermined target temperature, measuring the light emitted at the first area and the light emitted at the second area at a plurality of measurement temperatures to generate a plurality of first measured amounts of the light emitted at the first area and a plurality of second measured amounts of the light emitted at the second area, calculating a first current amount of the light emitted at the first area and a second current amount of the light emitted at the second area at the target temperature based on the plurality of first measured amounts and the plurality of second measured amounts, and determining whether to perform an image sticking compensation operation by comparing a ratio of the first current amount to the first initial amount and a ratio of the second current amount to the second initial amount.

The measuring the light emitted at the first area and the light emitted at the second area at the plurality of measurement temperatures can include measuring the light emitted at the first area and the light emitted at the second area at a first one of the measurement temperatures, adjusting a temperature of the display panel to a second one of the measurement temperatures by providing a display pattern to the display panel, and measuring the light emitted at the first area and the light emitted at the second area at the second one of the measurement temperatures.

The adjusting of the temperature of the display panel can include displaying an image based on the display pattern at the display panel, measuring the temperature of the display panel displaying the image by using a temperature sensor, and determining the measured temperature of the display panel as the second one of the measurement temperatures.

The temperature sensor can be disposed on a back surface of the display panel.

The display pattern can have the same grayscale value with respect to all pixels included in the display panel.

The first current amount can be calculated by interpolating the plurality of first measured amounts, and the second current amount can be calculated by interpolating the plurality of second measured amounts.

A degradation speed of the first area can be different from a degradation speed of the second area.

The image sticking compensation operation can be performed when the ratio of the first current amount to the first initial amount is different from the ratio of the second current amount to the second initial amount.

Another aspect is a degradation detecting device for a display panel including an initial amount storing unit configured to store a first initial amount of light emitted at a first area of the display panel and a second initial amount of light emitted at a second area of the display panel at a predetermined target temperature, a light detecting unit configured to measure the light emitted at the first area and the light emitted at the second area at a plurality of measurement temperatures to generate a plurality of first measured amounts of the light emitted at the first area and a plurality of second measured amounts of the light emitted at the second area, a current amount calculating unit configured to calculate a first current amount of the light emitted at the first area and a second current amount of the light emitted at the second area at the target temperature based on the plurality of first measured amounts and the plurality of second measured amounts, and a determining unit configured to determining whether to perform an image sticking compensation operation by comparing a ratio of the first current amount to the first initial amount and a ratio of the second current amount to the second initial amount.

The degradation detecting device for a display panel can further a temperature controlling unit configured to adjust a temperature of the display panel by providing a display pattern to the display panel, the light detecting unit can measure the light emitted at the first area and the light emitted at the second area at a first one of the measurement temperatures, the temperature controlling unit can adjust the temperature of the display panel from the first one of the measurement temperatures to a second one of the measurement temperatures, and the light detecting unit can measure the light emitted at the first area and the light emitted at the second area at the second one of the measurement temperatures.

The temperature controlling unit can display an image corresponding to the display pattern on the display panel, and measure the temperature of the display panel using a temperature sensor.

The temperature sensor can be disposed on a back surface of the display panel.

The display pattern can have the same grayscale value with respect to all pixels included in the display panel.

The current amount calculating unit can calculate the first current amount by interpolating the plurality of first measured amounts, and calculates the second current amount by interpolating the plurality of second measured amounts.

A light sensor can be disposed on a back surface of the display panel.

The determining unit can determine to perform the image sticking compensation operation when the ratio of the first current amount to the first initial amount is different from the ratio of the second current amount to the second initial amount.

Another aspect is a method of detecting degradation of a display panel, the method comprising storing first and second initial amounts of light respectively emitted at first and second areas of the display panel at a predetermined target temperature, measuring the brightnesses of the light emitted at the first and second areas at a plurality of measurement temperatures so as to generate a plurality of first and second measured amounts of the light respectively emitted at the first and second areas, calculating first and second current amounts of the light respectively emitted at the first and second areas at the target temperature based at least in part on the first and second measured amounts, and determining whether to perform an image sticking compensation operation on image data based at least in part on a comparison of a first ratio of the first current amount to the first initial amount and a second ratio of the second current amount to the second initial amount.

In the above method, the measuring includes measuring the light emitted at the first and second areas at a first one of the measurement temperatures, providing a display pattern to the display panel so as to adjust a temperature of the display panel to a second one of the measurement temperatures, and measuring the light emitted at the first and second areas at the second measurement temperature.

In the above method, the providing includes displaying an image based at least in part on the display pattern at the display panel, measuring the temperature of the display panel with a temperature sensor, and determining the measured temperature of the display panel as the second measurement temperatures.

In the above method, the temperature sensor is placed over a back surface of the display panel.

In the above method, the display pattern has substantially the same grayscale value with respect to substantially every pixel included in the display panel.

In the above method, the first and second current amounts are calculated by respectively interpolating the first and second measured amounts.

In the above method, a degradation speed of the first area is different from a degradation speed of the second area.

In the above method, the image sticking compensation operation is performed when the first and second ratios are different.

Another aspect is a degradation detecting device for a display panel, the device comprising an initial amount storing unit configured to store first and second initial amounts of light respectively emitted at first and second areas of the display panel at a predetermined target temperature and a light measuring unit configured to i) measure the brightnesses of the light emitted at the first and second areas at a plurality of measurement temperatures and ii) generate a plurality of first and second measured amounts of the light respectively emitted at the first and second areas. The device also comprises a current amount calculator configured to calculate first and second current amounts of the light emitted at the first and second areas at the target temperature respectively based at least in part on the first and second measured amounts and a determining unit configured to compare a first ratio of the first current amount to the first initial amount and a second ratio of the second current amount to the second initial amount so as to determine whether to perform an image sticking compensation operation on image data to be displayed on the display panel.

The above device further comprises a temperature controller configured to provide a display pattern to the display panel so as adjust a temperature of the display panel, wherein the light measuring unit is further configured to measure the light emitted at the first and second areas at a first measurement temperature, wherein the temperature controller is further configured to adjust the temperature of the display panel from the first one of the measurement temperatures to a second one of the measurement temperatures, and wherein the light measuring unit is further configured to measure the light emitted at the first and second areas at the second measurement temperature.

The above device further comprises a temperature sensor configured to measure the temperature of the display panel, wherein the temperature controller is configured to display an image corresponding to the display pattern on the display panel.

In the above device, the temperature sensor is placed on a back surface of the display panel.

In the above device, the display pattern has substantially the same grayscale value with respect to every pixel included in the display panel.

In the above device, the current amount is further configured to interpolate the first and second measured amounts so as to respectively calculate the first and second measurement amounts.

The above device further comprises a light sensor placed on a back surface of the display panel.

In the above device, the determining unit is configured to perform the image sticking compensation operation on the image data when the first ratio is different from the second ratio.

Another aspect is a degradation detecting device for a display panel, the device comprising a light measuring unit configured to i) measure the brightnesses of light emitted at first and second areas of the display panel at a plurality of measurement temperatures and ii) generate a plurality of first and second measured amounts of the light respectively emitted at the first and second areas. The device also comprises a current amount calculator configured to calculate first and second current amounts of the light emitted at the first and second areas at a predetermined target temperature respectively based at least in part on the first and second measured amounts. The device further comprises a determining unit configured to compare a first ratio of the first current amount to a first initial amount and a second ratio of the second current amount to a second initial amount so as to determine whether to perform an image sticking compensation operation on image data to be displayed on the display panel.

The above device further comprises an initial amount storing unit configured to store the first and second initial amounts of light respectively emitted at the first and second areas of the display panel at the predetermined target temperature.

In the above device, the determining unit is configured to perform the image sticking compensation operation on the image data when the first ratio is different from the second ratio.

The above device further comprises a temperature controller configured provide a display pattern to the display panel so as to adjust a temperature of the display panel, wherein the light measuring unit is further configured to measure the light emitted at the first and second areas at a first measurement temperatures, wherein the temperature controller is further configured to adjust the temperature of the display panel from the first measurement temperature to a second measurement temperature, and wherein the light measuring unit is further configured to measure the light emitted at the first and second areas at the second measurement temperature.

According to at least one of the disclosed embodiments, a method of detecting degradation and a degradation detecting device of a display panel according to example embodiments can accurately detect the degradation of the display panel by adjusting a temperature of the display panel using a display pattern, measuring a light emitted at the display panel at the adjusted temperature, and calculating an amount of light at a predetermined target temperature based on an amount of the light at the adjusted temperature.

### BRIEF DESCRIPTION OF THE DRAWINGS

FIG. 1 is a flowchart illustrating a method of detecting degradation of a display panel according to example embodiments.

FIG. 2 is a diagram illustrating a display panel for describing the method of detecting degradation of the display panel of FIG. 1.

FIGS. 3A and 3B are diagrams for describing examples of which a first current amount is calculated by the method of detecting degradation of the display panel of FIG. 1.

FIGS. 4A and 4B are diagrams for describing examples of which a second current amount is calculated by the degradation detecting method of the display panel of FIG. 1.

FIG. 5 is a block diagram illustrating a degradation detecting device of a display panel according to example embodiments.

FIG. 6 is a diagram illustrating an example in which the display panel is coupled to the degradation detecting device of FIG. 5.

FIG. 7 is a block diagram illustrating a display device having the degradation detecting device of FIG. 5.

FIG. 8 is a block diagram illustrating an electronic device having the display device of FIG. 7.

FIG. 9 is a diagram illustrating an example in which the electronic device of FIG. 8 is implemented as a smartphone.

### DETAILED DESCRIPTION OF CERTAIN INVENTIVE EMBODIMENTS

Organic light-emitting diodes (OLEDs) can degrade and therefore, the brightness of emitted light can decrease over time. Thus, a method that detects a degree of degradation of the OLED and compensates the degradation is being developed. When the degradation is detected based on an amount of the light from a display panel, the detected amount of light using a light sensor can be changed.

Hereinafter, the described technology will be explained in detail with reference to the accompanying drawings. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

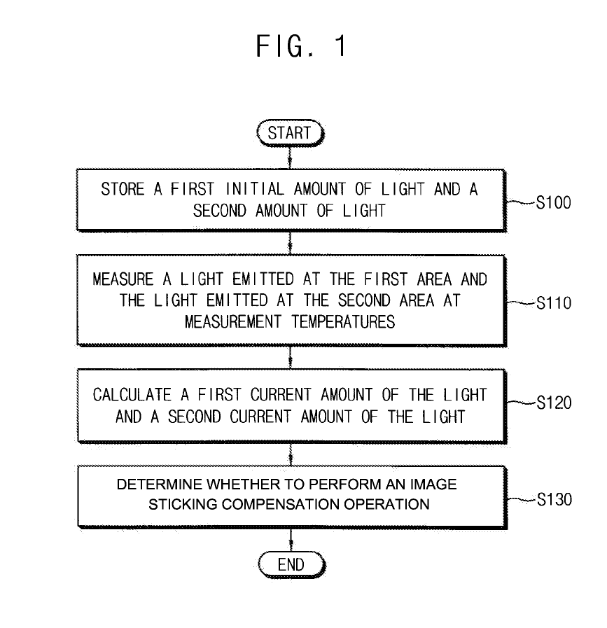

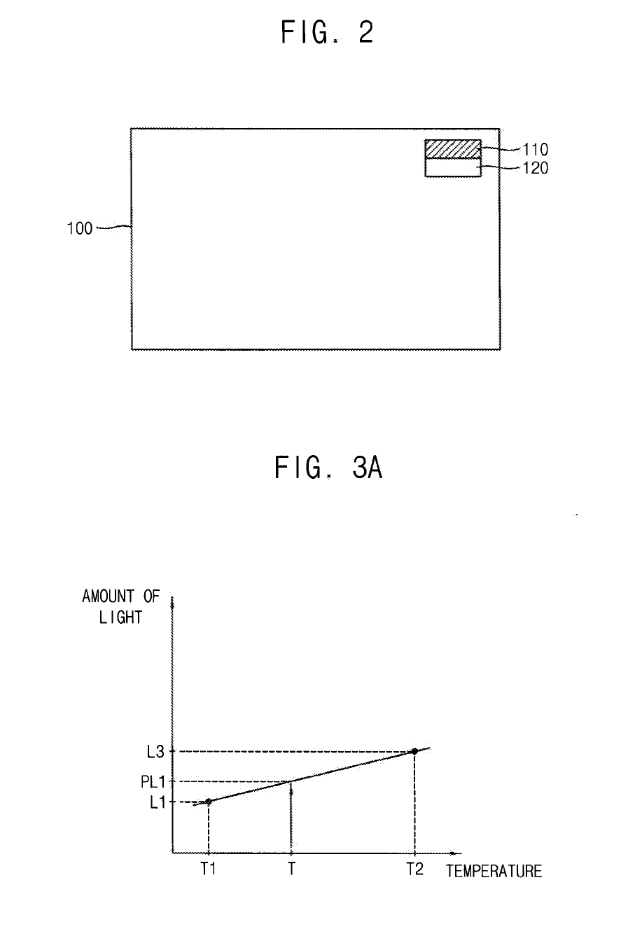

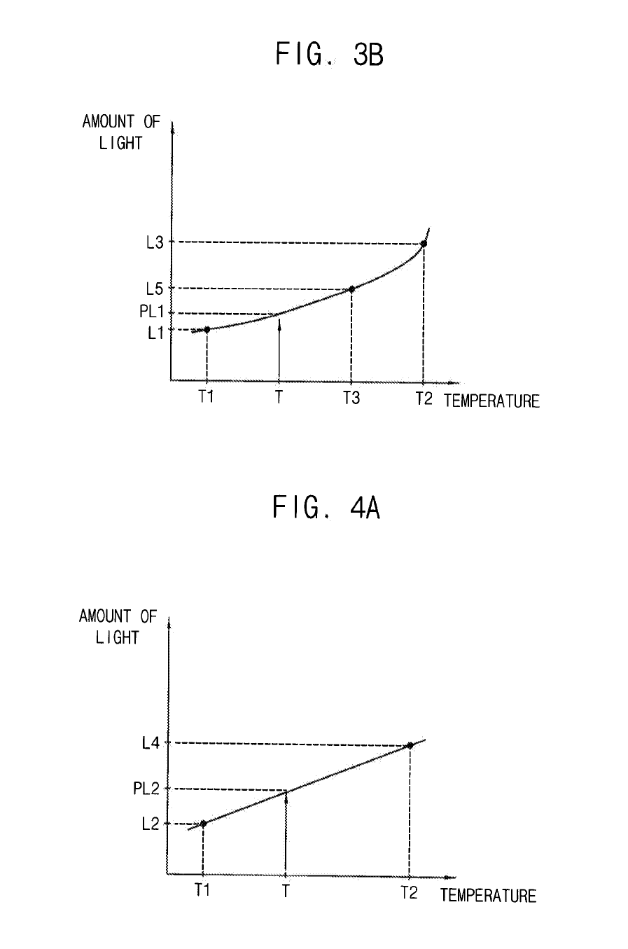

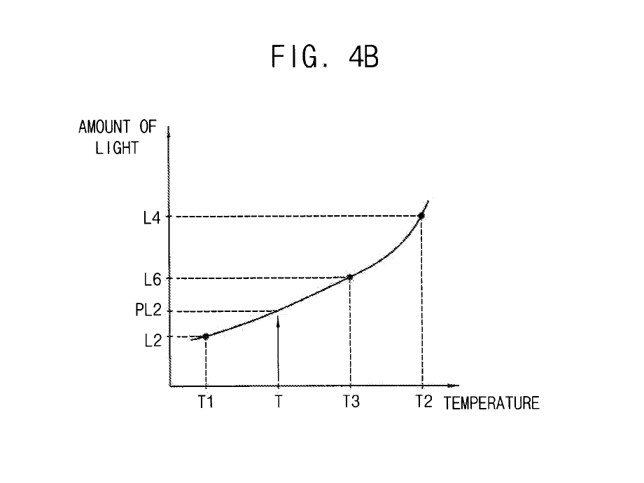

FIG. 1 is a flowchart illustrating a method of detecting degradation of a display panel according to example embodiments. FIG. 2 is a diagram illustrating a display panel for describing the method of detecting degradation of the display panel of FIG. 1. FIGS. 3A and 3B are diagrams for describing examples of which a first current amount is calculated by the method of detecting degradation of the display panel of FIG. 1. FIGS. 4A and 4B are diagrams for describing examples of which a second current amount is calculated by the degradation detecting method of the display panel of FIG. 1.

Referring to FIGS. 1 and 2, a method of detecting degradation of a display panel includes storing a first initial amount of light emitted at a first area of the display panel and a second initial amount of light emitted at a second area of the display panel at a predetermined target temperature (S100). The method also includes measuring the light emitted at the first area and the light emitted at the second area at a plurality of measurement temperatures to generate a plurality of first measured amounts of the light emitted at the first area and a plurality of second measured amounts of the light emitted at the second area (S110). The method also includes calculating a first current amount of the light emitted at the first area and a second current amount of the light emitted at the second area at the target temperature based on the first and second measured amounts (S120). The method includes determining whether to perform an image sticking compensation operation on image data to be displayed on the display panel by comparing a ratio of the first current amount to the first initial amount and a ratio of the second current amount to the second initial amount (S130).

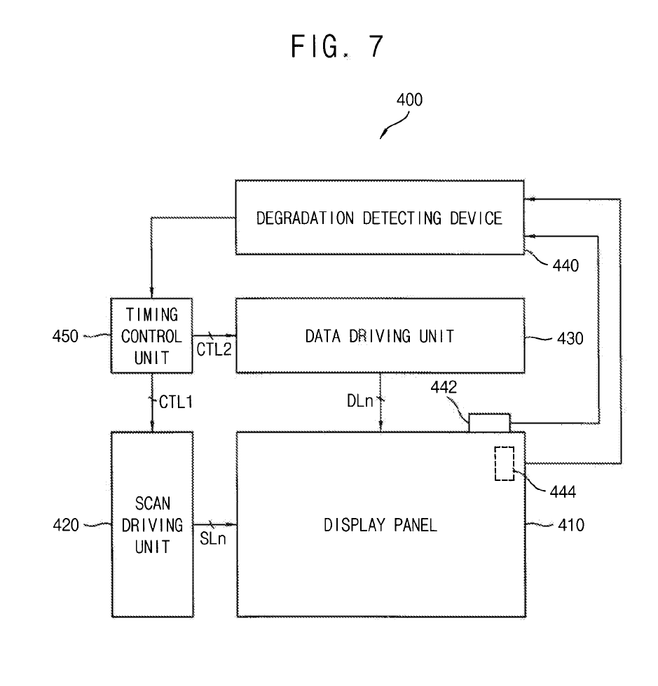

In some embodiments, the FIG. 1 procedure is implemented in a conventional programming language, such as C or C++ or another suitable programming language. The program can be stored on a computer accessible storage medium of a display device 400 (see FIG. 7), for example, a memory (not shown) of the display device 400 or a timing control unit 450 (see FIG. 7). In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 1.

In S100, degradation speed of the first area 110 can be different from the degradation speed of the second area 120. The first area 110 can be an area that degrades faster than other areas because a driving time of the first area 110 is longer than the other areas or an image having a high brightness is displayed on the first area 110. For example, when the display panel 100 is included in a television device, the first area 110 is an area where a logo of a broadcasting company is displayed. Generally, the area where the logo is displayed degrades faster than other areas because the logo having high brightness, e.g. white color, is displayed all the time. The second area 120 of the display panel 100 can be an area where a general image is displayed. The second area 120 can have substantially the same size as the first area 110. The first initial amount and the second initial amount can be measured and stored in the factory before shipment. The first and second initial amounts can be detected using a light sensor that is placed on a side of the display panel 100. The light sensor can include a red light sensor, a green light sensor, and a blue light sensor. The red, green, and blue light output from the display panel 100 can be respectively detected by the red, green, and blue light sensors.

In S110, the temperature of the display panel 100 can be adjusted based at least in part on an image that is displayed on the display panel 100. The image can be displayed on the display panel 100, and the temperature of the display panel 100 can be measured using a temperature sensor. The measured temperature can be determined as the first measurement temperature. Further, the second display pattern can be displayed on the display panel 100, the temperature of the display panel 100 can be measured using the temperature sensor, and the measured temperature of the display panel 100 can be determined as the second measurement temperature. Here, the first display pattern and the second display pattern can have substantially the same grayscale value with respect to all pixels included in the display panel 100. The grayscale value of the first display pattern is different from the grayscale value of the second display pattern. For example, the first display pattern has a 0 grayscale value and the second display pattern has a 255 grayscale value. The temperature sensor can be placed on a back surface of the display panel 100. Although the method for adjusting the measurement temperature of the display panel 100 using the display pattern is described, the method is not limited thereto. The measurement temperature can be adjusted by displaying a display pattern on the display panel 100 and controlling a level of a voltage for outputting the display pattern, e.g. ELVDD or ELVSS. Further, the measurement temperature can be adjusted by displaying a display pattern on the display panel 100 and controlling an emitting time of an OLED for outputting the display pattern.

The method of FIG. 1 can include generating a plurality of first measured amounts of the light emitted at the first area 110 by measuring the light emitted at the first area 110 at a first one of the measurement temperatures. The method can also include adjusting the temperature of the display panel 100 to a second one of the measurement temperatures by providing a display pattern to the display panel 100. The method can also include measuring the light emitted at the first area 110 at the second one of the measurement temperatures. The first measured amounts are not limited to the light emitted at the first area 110 at the first and second measurement temperatures. For example, the first measured amount can further include a light emitted at the first area 110 at the third measurement temperature. Further, the method of detecting degradation of FIG. 1 can include generating a plurality of second measured amount of the light emitted at the second area 120 by measuring the light emitted at the second area 120 at the first one of the measurement temperatures. The method can also include adjusting the temperature of the display panel 100 to the second one of the measurement temperatures by providing the display pattern to the display panel 100, and measuring the light emitted at the second area 120 at the second one of the measurement temperatures. The second measured amounts of the light are not be limited to the light emitted at the second area 120 at the first and second measurement temperatures. For example, the second measured amount can further include a light emitted at the second area 120 at the third measurement temperature.

Referring to FIGS. 3A and 3B, the first current amount is calculated based at least in part on the first measured amounts. For example, the first current amount PL1 is calculated by interpolating the first measured amounts. In some embodiments, when the first measured amounts include a first light L1 at the first measurement temperature T1 and a third light L3 at the second measurement temperature T2, the first measured amounts are interpolated using a linear interpolation method as illustrated in FIG. 3A. The first current amount PL1 at the target temperature T can be calculated based at least in part on the interpolated first measured amounts. Here, the target temperature T can be a predetermined temperature and can be substantially the same as the temperature at which the first initial amount of light is measured. In some embodiments, when the first measured amounts include a first light L1 at the first measurement temperature T1, a third light L3 at the second measurement temperature T2, and a fifth light L5 at the third measurement temperature T3, the first measured amounts can be interpolated using a polynomial interpolation method as illustrated in FIG. 3B. The first current amount PL1 at the target temperature T can be calculated based at least in part on the interpolated first measured amounts. The first measured amounts at the measurement temperatures can be interpolated and the first current amount of the light can be calculated based at least in part on the interpolated first measured amounts. Although the method for interpolating the first measured amounts using the linear interpolation method and the polynomial interpolation method is described, the method for interpolating the first measured amounts is not limited thereto.

Referring to FIGS. 4A and 4B, the second current amount is calculated based on the second measured amounts. For example, the second current amount PL2 is calculated by interpolating the second measured amounts. In some embodiments, when the second measured amounts include a second light L2 at the first measurement temperature T1 and a fourth light L4 at the second measurement temperature T2, the second measured amounts are interpolated using the linear interpolation method as illustrated in FIG. 4A. The second current amount PL2 at the target temperature T can be calculated based on the interpolated second measured amounts. Here, the target temperature T can be a predetermined temperature and can be substantially the same as the temperature at which the second initial amount of light is measured. In some embodiments, when the second measured amounts include the second light L2 at the first measurement temperature T1, the fourth light L4 at the second temperature T2, and a sixth light L6 at the third temperature T3, the second measured amounts are interpolated using the polynomial interpolation method as illustrated in FIG. 4B. The second current amount of the light PL2 at the target temperature T can be calculated based on the interpolated second measured amounts. As described, the second measured amounts at the measurement temperatures can be interpolated and the second current amount of the light can be calculated based on the interpolated second measured amounts. Although the method for interpolating the second measured amounts using the linear interpolation method and the polynomial interpolation method is described, the method for interpolating the second measured amounts is not limited thereto.

In S130, the ratio of the first current amount to the first initial amount represents a changed amount of the light emitted at the first area 110. The ratio of the second current amount to the second initial amount represents a changed amount of the light emitted at the second area 120. The degradation method of FIG. 1 includes detecting a degree of degradation of the pixels at the first and second areas 110 and 120 by comparing the ratio of the first current amount to the first initial amount and the ratio of the second current amount to the second initial amount and determining whether to perform the image sticking compensation operation. The image sticking compensation operation can be operated when the ratio of the first current amount to the first initial amount is different from the ratio of the second current amount to the second initial amount. For example, the first current amount measured at the first area 110 is smaller than the second current amount measured at the second area 120 because the degradation speed of the first area 110 on which the image having high brightness is displayed is faster than the degradation speed of the second area 120. That is, the image sticking can be recognized by the brightness differential between the first area 110 and the second area 120. Thus, the image sticking of the first and second areas 110 and 120 can be compensated by employing the image sticking compensation operation. For example, the image sticking compensation operation can be a stress boundary diffusion (SBD) technique.

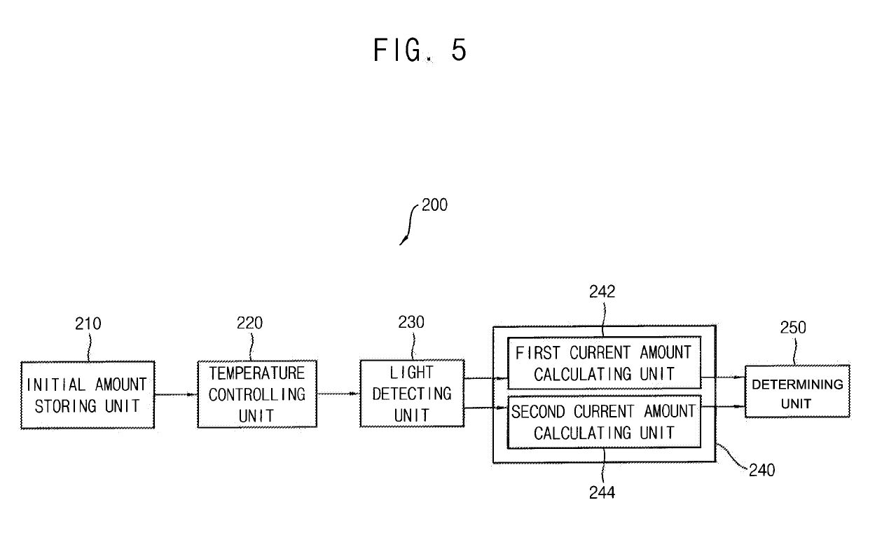

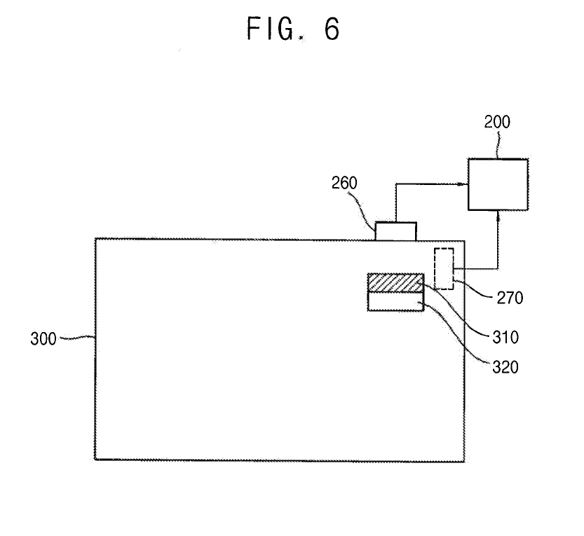

FIG. 5 is a block diagram illustrating a degradation detecting device of a display panel according to example embodiments. FIG. 6 is a diagram illustrating an example in which the display panel is coupled to the degradation detecting device of FIG. 5. The descriptions of the elements and steps in FIGS. 1-4 can apply to the elements of the same names in FIGS. 5 and 6. Therefore, repeated discussions are omitted for simplicity.

Referring to FIGS. 5 and 6, a degradation detecting device or degradation detector 200 include an initial amount storing unit 210, a temperature controlling unit or temperature controller 220, a light detecting unit or light measuring unit 230, a current amount calculating unit or current amount calculator 240, and a determining unit 250.

Referring to FIG. 6, the display panel 300 includes a first area 310 and a second area 320.

A light sensor 260 can be placed on a side of the display panel 300 to detect the amount of light at the first area 310 and the second area 320. The light sensor 260 can be coupled to the degradation detecting device 200. The light sensor 260 can transfer the amount of light detected at the first and second areas 310 and 320 to the degradation device 200. Further, a temperature sensor 270 can be placed on a back surface of the display panel 300 to detect the temperature of the display panel 300. The temperature sensor 270 can be coupled to the degradation detecting device 200. The temperature sensor 270 can transfer the temperature of the display panel 300 to the degradation detecting device 200.

Referring to FIG. 5, the initial amount storing unit 210 stores a first initial amount of light emitted at the first area 310 and a second initial amount of light emitted at the second area 320 at a predetermined target temperature. The first and second initial amounts can be measured and stored in the factory before shipment of the display device. The first and second initial amounts can be detected using a light sensor 260. The light sensor 260 can include a red light sensor, a green light sensor, and a blue light sensor. The red, green, and blue light output from the display panel 300 can be respectively detected by the red, green, and blue light sensors.

The temperature controlling unit 220 can adjust a temperature of the display panel 300 by providing a display pattern to the display panel 300. The temperature controlling unit 220 can display a first display pattern on the display panel 300, measure the temperature of the display panel 300 using the temperature sensor 270, and determine the measured temperature of the display panel 300 as a first measurement temperature. Further, the temperature controlling unit 220 can adjust the temperature of the display panel 300 from the first measurement temperature to a second measurement temperature. The temperature controlling unit 220 can display a second display pattern on the display panel 300, measure the temperature of the display panel 300 using the temperature sensor 270, and determine the measured temperature of the display panel as a second measurement temperature.

The light detecting unit 230 can measure the brightness of the light emitted at the first area 310 and the brightness the light emitted at the second area 320 at the plurality of measurement temperatures to generate the first measured amounts of the light emitted at the first area and the second measured amounts of the light emitted at the second area. When the temperature controlling unit 220 adjusts the temperature of the display panel 300 to the first measurement temperature by displaying the first display pattern on the display panel 300, the light detecting unit 230 can measure the light emitted at the first area 310 and the light emitted at the second area 320 using the light sensor 260. Further, when the temperature controlling unit 220 adjusts the temperature of the display panel 300 to the second measurement temperature by displaying the second display pattern on the display panel 300, the light detecting unit 230 can measure the light emitted at the first area 310 and the light emitted at the second area 320 using the light sensor 260. Here, the light detecting unit 230 can generate the first measured amounts using the light emitted at the first area 310 at the first and second measurement temperatures. Further, the light detecting unit 230 can generate the second measured amounts of the light using the light emitted at the second area 320 at the first and second measurement temperatures, but the first and second measured amounts are not limited thereto. For example, the first measured amounts can further include the light emitted at the first area 310 at a third measurement temperature and the second measured amounts can further include the light emitted at the second area 320 at the third measurement temperature.

The current amount calculating unit 240 can include a first and second current amount calculating units 242 and 244.

The first current amount calculating unit 242 can calculate the first current amount based at least in part on the first measured amounts. The first current amount calculating unit 242 can interpolate the first measured amounts and calculate the first current amounts at the target temperature based at least in part on the first measured amounts. In some embodiments, when the first measured amount include a first light emitted at the first area 310 at the first measurement temperature and a third light emitted at the first area 310 at the second measurement temperature, the first current amount calculating unit 242 can interpolate the first measured amounts using a linear interpolation method. The first current amount calculating unit 242 can calculate the first current amounts at the target temperature based at least in part on the interpolated first measured amounts. Here, the target temperature can be a predetermined temperature and can be the same as the temperature at which the first initial amount of the light is measured. In some embodiments, when the first measured amount include a first light emitted at the first area 310 at the first measurement temperature, a third light emitted at the first area 310 at the second measurement temperature, and a fifth light emitted at the first area 310 at the third measurement temperature, the first current amount calculating unit 242 can interpolate the first measured amounts using a polynomial interpolation method. The first current amount calculating unit 242 can calculate the first current amounts at the target temperature based at least in part on the interpolated first measured amounts. As described, the first current amount calculating unit 242 can interpolate the first measured amounts at the measurement temperatures and calculate the first current amounts based at least in part on the interpolated first measured amounts.

The second current amount calculating unit 244 can calculate a second current amount of the light emitted at the second area at the target temperature based on the second measured amounts. The second current amount calculating unit 244 can interpolate the second measured amounts and calculate the second current amounts. In some embodiments, when the second measured amount include a second light emitted at the second area 320 at the first measurement temperature and a fourth light emitted at the second area 320 at the second measurement temperature, the second current amount calculating unit 244 can interpolate the second measured amounts using the linear interpolation method. The second current amount calculating unit 244 can calculate the second current amounts at the target temperature based on the interpolated second measured amounts. Here, the target temperature can be the predetermined temperature and can be substantially the same as the temperature at which the second initial amount of the light measured. In some embodiments, when the second measured amount include a second light emitted at the second area 320 at the first measurement temperature, a fourth light emitted at the second area 320 at the second measurement temperature, and a sixth light emitted at the second area 320 at the third measurement temperature, the second current amount calculating unit 244 can interpolate the second measured amounts using the polynomial interpolation method. The second current amount calculating unit 244 can calculate the second current amounts at the target temperature based on the interpolated second measured amounts. The second current amount calculating unit 244 can interpolate the second measured amounts at the measurement temperatures and calculate the second current amounts based at least in part on the interpolated second measured amounts.

The determining unit 250 can determine whether to perform the image sticking compensation operation. The operation is performed by comparing the ratio of the first current amount to the first initial amount and the ratio of the second current amount to the second initial amount. The ratio of the first current amount to the first initial amount represents a changed amount of the light emitted at the first area 310. The ratio of the second current amount to the second initial amount represents a changed amount of the light emitted at the second area 320. The determining unit 250 can detect a degree of degradation of the pixels at the first area 310 and at the second area 320 by comparing the ratio of the first current amount to the first initial amount and the ratio of the second current amount to the second initial amount and can determine whether to perform the image sticking compensation operation. The image sticking compensation operation can be performed when the ratio of the first current amount to the first initial amount is different from the ratio of the second current amount to the second initial amount. For example, the first current amount measured at the first area 310 is smaller than the second current amount measured at the second area 320 because the degradation speed of the first area 310 on which the image having high brightness is displayed is faster than the degradation speed of the second area 320. That is, the image sticking can be recognized by the brightness differential between the first area 310 and the second area 320. Thus, the determining unit 250 can compensate the image sticking of the first area 310 and the second area 320 by operating the image sticking compensation operation. For example, the image sticking compensation operation is a stress boundary diffusion (SBD) technique.

The degradation of the display panel 300 can be accurately detected regardless of the temperature by calculate the first present amount of the first area 310 and the second present amount of light of the second area 320 at the target temperature.

FIG. 7 is a block diagram illustrating a display device having the degradation detecting device of FIG. 5.

Referring to FIG. 7, the display device 400 includes a display panel 410, a scan driving unit or scan driver 420, a data driving unit or data driver 430, a degradation detecting device 440, and a timing control unit 450. Here, the degradation detecting device 440 can correspond to the degradation detecting device 200 of FIG. 5.

The display panel 410 includes a plurality of pixels. Here, each pixel can include an OLED. In some embodiments, each pixel can also include a pixel circuit and a driving transistor. In this case, the pixel circuit provides a data signal via data-lines DLm to the driving transistor based at least in part on a scan signal provided via scan-lines SLn. The driving transistor can control a current flowing through the OLED based at least in part on the data signal, and the OLED can emit light based on the current. An amount of light of the display panel 410 can be detected using a light sensor 442. A temperature of the display panel 410 can be measured using a temperature sensor 444 placed on the back surface of the display panel 410. The scan driving unit 420 can provide the scan signal to the pixels via the scan-lines SLn. The data driving unit 430 can provide the data signal to the pixels via the data-lines DLm.

The timing control unit 450 can control the scan driving unit 420, the data driving unit 430, and the degradation detecting device 440 by generating a plurality of control signals CTL1 and CTL2.

Here, the degradation detecting device 440 can accurately detect the degradation of the display panel 410 regardless of the temperature by calculating the first and second current amounts.

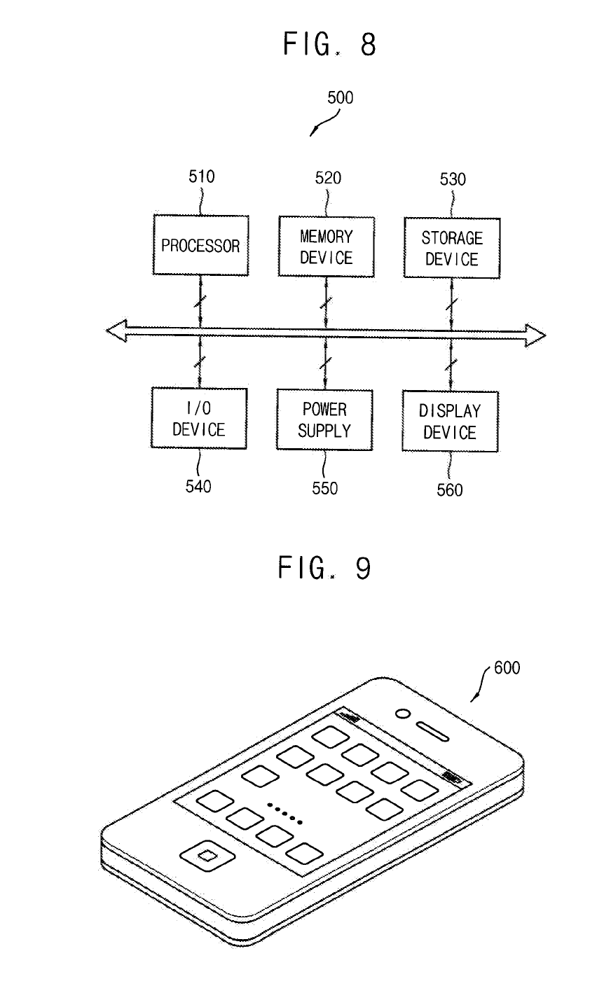

FIG. 8 is a block diagram illustrating an electronic device having the display device 400 of FIG. 7. FIG. 9 is a diagram illustrating an example in which the electronic device 500 of FIG. 8 is implemented as a smartphone.

Referring to FIGS. 8 and 9, the electronic device 500 includes a processor 510, a memory device 520, a storage device 530, an input/output (I/O) device 540, a power supply 550 and a display device 560. Here, the display device 560 can correspond to the display device 400 of FIG. 7. In addition, the electronic device 500 can further include a plurality of ports for communicating a video card, a sound card, a memory card, a universal serial bus (USB) device, other electronic devices, etc. Although it is illustrated in FIG. 9 that the electronic device 500 is implemented as a smartphone 500, the kind of the electronic device 500 is not limited thereto.

The processor 510 can perform various computing functions. The processor 510 can be a microprocessor, a central processing unit (CPU), etc. The processor 510 can be coupled to other components via an address bus, a control bus, a data bus, etc. Further, the processor 510 can be coupled to an extended bus such as peripheral component interconnect (PCI) bus. The memory device 520 can store data for operations of the electronic device 600. For example, the memory device 520 includes at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano-floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile DRAM device, etc. The storage device 530 can be a solid state drive (SSD) device, a hard disk drive (HDD) device, a CD-ROM device, etc.

The I/O device 540 can be an input device such as a keyboard, a keypad, a touchpad, a touchscreen, a mouse, etc, and an output device such as a printer, a speaker, etc. In some embodiments, the display device 560 can be included in the I/O device 540. The power supply 550 can provide power for operations of the electronic device 500. The display device 560 can communicate with other components via the buses or other communication links. As described, the display device 560 can include the degradation detecting device.

The described technology can be applied to an electronic device having a display device. For example, the described technology can be applied to a computer monitor, a laptop, a digital camera, a cellular phone, a smartphone, a smart pad, a television, a personal digital assistant (PDA), a portable multimedia player (PMP), a MP3 player, a navigation system, a game console, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive technology. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of detecting degradation of a display panel, the method comprising:
storing first and second initial amounts of light respectively emitted at first and second areas of the display panel at a predetermined target temperature;
measuring the brightnesses of the light emitted at the first and second areas at a plurality of measurement temperatures so as to generate a plurality of first and second measured amounts of the light respectively emitted at the first and second areas;
calculating first and second current amounts of the light respectively emitted at the first and second areas at the target temperature based at least in part on the first and second measured amounts; and
determining whether to perform an image sticking compensation operation on image data based at least in part on a comparison of a first ratio of the first current amount to the first initial amount and a second ratio of the second current amount to the second initial amount.

2. The method of claim 1, wherein the measuring includes:
measuring the light emitted at the first and second areas at a first one of the measurement temperatures;
providing a display pattern to the display panel so as to adjust a temperature of the display panel to a second one of the measurement temperatures; and
measuring the light emitted at the first and second areas at the second measurement temperature.

3. The method of claim 2, wherein the providing includes:
displaying an image based at least in part on the display pattern at the display panel;
measuring the temperature of the display panel with a temperature sensor; and
determining the measured temperature of the display panel as the second measurement temperatures.

4. The method of claim 3, wherein the temperature sensor is placed over a back surface of the display panel.

5. The method of claim 2, wherein the display pattern has substantially the same grayscale value with respect to substantially every pixel included in the display panel.

6. The method of claim 1, wherein the first and second current amounts are calculated by respectively interpolating the first and second measured amounts.

7. The method of claim 1, wherein a degradation speed of the first area is different from a degradation speed of the second area.

8. The method of claim 1, wherein the image sticking compensation operation is performed when the first and second ratios are different.

9. A degradation detecting device for a display panel, the device comprising:
an initial amount storing unit configured to store first and second initial amounts of light respectively emitted at first and second areas of the display panel at a predetermined target temperature;
a light measuring unit configured to i) measure the brightnesses of the light emitted at the first and second areas at a plurality of measurement temperatures and ii) generate a plurality of first and second measured amounts of the light respectively emitted at the first and second areas;
a current amount calculator configured to calculate first and second current amounts of the light emitted at the first and second areas at the target temperature respectively based at least in part on the first and second measured amounts; and
a determining unit configured to compare a first ratio of the first current amount to the first initial amount and a second ratio of the second current amount to the second initial amount so as to determine whether to perform an image sticking compensation operation on image data to be displayed on the display panel.

10. The device of claim 9, further comprising:
a temperature controller configured to provide a display pattern to the display panel so as adjust a temperature of the display panel,
wherein the light measuring unit is further configured to measure the light emitted at the first and second areas at a first measurement temperature,
wherein the temperature controller is further configured to adjust the temperature of the display panel from the first one of the measurement temperatures to a second one of the measurement temperatures, and
wherein the light measuring unit is further configured to measure the light emitted at the first and second areas at the second measurement temperature.

11. The device of claim 10, further comprising a temperature sensor configured to measure the temperature of the display panel, wherein the temperature controller is configured to display an image corresponding to the display pattern on the display panel.

12. The device of claim 11, wherein the temperature sensor is placed on a back surface of the display panel.

13. The device of claim 10, wherein the display pattern has substantially the same grayscale value with respect to every pixel included in the display panel.

14. The device of claim 9, wherein the current amount is further configured to interpolate the first and second measured amounts so as to respectively calculate the first and second measurement amounts.

15. The device of claim 9, further comprising a light sensor placed on a back surface of the display panel.

16. The device of claim 9, wherein the determining unit is configured to perform the image sticking compensation operation on the image data when the first ratio is different from the second ratio.

17. A degradation detecting device for a display panel, the device comprising:
a light measuring unit configured to i) measure the brightnesses of light emitted at first and second areas of the display panel at a plurality of measurement temperatures and ii) generate a plurality of first and second measured amounts of the light respectively emitted at the first and second areas;
a current amount calculator configured to calculate first and second current amounts of the light emitted at the first and second areas at a predetermined target temperature respectively based at least in part on the first and second measured amounts; and
a determining unit configured to compare a first ratio of the first current amount to a first initial amount and a second ratio of the second current amount to a second initial amount so as to determine whether to perform an image sticking compensation operation on image data to be displayed on the display panel.

18. The device of claim 17, further comprising an initial amount storing unit configured to store the first and second initial amounts of light respectively emitted at the first and second areas of the display panel at the predetermined target temperature.

19. The device of claim 18, wherein the determining unit is configured to perform the image sticking compensation operation on the image data when the first ratio is different from the second ratio.

20. The device of claim 17, further comprising a temperature controller configured provide a display pattern to the display panel so as to adjust a temperature of the display panel,
wherein the light measuring unit is further configured to measure the light emitted at the first and second areas at a first measurement temperatures,
wherein the temperature controller is further configured to adjust the temperature of the display panel from the first measurement temperature to a second measurement temperature, and
wherein the light measuring unit is further configured to measure the light emitted at the first and second areas at the second measurement temperature.
